(19) United States
(12) Patent Application Publication
(10) Pub. No.: US 2009/0042585 A1
(43) Pub. Date: Feb. 12, 2009

(54) TERMINAL POSITIONING METHOD, TERMINAL POSITIONING SYSTEM, POSITIONING SERVER, AND PROGRAM

(75) Inventor: Junichi Matsuda, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/293,248

(22) PCT Filed: Mar. 16, 2007
(86) PCT No.: PCT/JP2007/055343

§ 371 Date: Sep. 16, 2008

(30) Foreign Application Priority Data
Mar. 17, 2006 (JP) 2006-074679

(51) Int. Cl. H04W 4/02

(52) U.S. Cl. 455/456.1

(57) ABSTRACT

[Subject] The present invention is directed to realize failure detection without directly detecting a failed positioning system.

[Solving Means] A terminal positioning system includes positioning systems 101 and 102 and a failure detector 104. When a failure occurs in one of the positioning systems 101 and 102, by monitoring a use state of the other positioning system, the failure in one of the positioning systems is detected. Priorities of positioning process on the positioning systems 101 and 102 may be determined so that the priority of positioning process on one of the positioning systems is higher than that on the other positioning system. The one of the positioning systems can perform positioning at higher precision than the other positioning system.

### TECHNICAL FIELD

The present invention relates to a terminal positioning method, a terminal positioning system, a positioning server, and a program for specifying the position of a terminal by combining a plurality of positioning systems and particularly, to a technique for detecting a failure of a positioning system used.

### BACKGROUND ART

In recent years, demand for location information service that specifies the position of a user or a terminal and provides service according to the specified position is increasing. A positioning system using GPS satellite is practically used outdoors. In doors, a positioning system using a datum point that generates RF-ID (Radio Frequency Identification), infrared rays, or the like (hereinbelow, the positioning system is described as datum-point positioning) is actively being examined.

As the datum-point positioning, for example, there is a method of transmitting unique information such as ID number from a transmitter for transmitting RF-ID, infrared rays, and the like, and converting the ID number received by a terminal to information of the position where the transmitter is installed, thereby specifying the position of the terminal.

In the case of the datum-point positioning, when a transmitter fails for some reason and the ID number cannot be transmitted, the positioning cannot be performed. To provide stable service, it is important to detect a failure in a transmitter.

To deal with the problem, as described in Patent Document 1, there is a method of detecting that a wireless tag as a transmitter fails in the case where identification information peculiar to the wireless tag is not received for a predetermined period or longer from the wireless tag.

As described in Patent Document 2, there is another method. In a system using an RF-ID as a transmitter, information is read from all of RF-IDs installed. An RF-ID from which information cannot be read is regarded as a failed one.

Methods of detecting a failure of a wireless base station, which are not limited to the datum-point positioning are described in Patent Documents 3 and 4. In Patent Documents 3 and 4, a wireless base station detects disconnection of a wired network connected to the wireless base station and a failure of a wired communication unit. The failure information is notified by using a wireless network.

Patent document 1: Japanese Patent Application Laid-Open (JP-A) No. 2004-252790
Patent document 2: Japanese Patent Application Publication (Laid-Open) No. 2003-519878
Patent document 3: Japanese Patent Application Laid-Open (JP-A) No. 2004-56449
Patent document 4: Japanese Patent Application Laid-Open (JP-A) No. 2000-156689

### DISCLOSURE OF THE INVENTION

### Problem to be Solved by the Invention

As described above, some methods of detecting a failure in a transmitter necessary for the datum-point positioning have been devised. However, the conventional methods have some drawbacks.

A first drawback is that when a check is made to see whether a signal is not received for a predetermined period or longer, absence of a receiver in the communication range of a transmitter used for the datum-point positioning and failure of the transmitter cannot be distinguished from each other.

A second drawback is that the method of checking whether information is transmitted from all of transmitters or not in order to perform failure detection in a large-scale system having enormous number of transmitters is not a realistic method.

A third drawback is that, in the case where a transmitter is not connected to a wired network, if a radio communication part fails, a failure cannot be notified.

An object of the present invention is to provide a method and system capable of solving the drawbacks and performing failure detection without directly detecting a failed positioning system, particularly, a method and system facilitating detection of a failure in a transmitter in a large-scale datum-point positioning system having a large number of transmitters which are not connected to a wired network.

### Means for Solving the Problem

The present invention provides a terminal positioning method of specifying position of a terminal by using at least one of a plurality of positioning systems, wherein a use state of one or a plurality of first positioning systems is monitored by a failure detector, thereby detecting a failure of at least one second positioning system other than the one or more first positioning systems.

The present invention provides a terminal positioning system including a plurality of positioning systems and specifying position of a terminal by using at least one of the plurality of positioning systems, wherein a use state of one or a plurality of first positioning systems in the plurality of positioning systems is monitored by a failure detector, thereby detecting a failure in at least one second positioning system other than the one or more first positioning systems.

In the case where the second positioning system fails, the frequency of using one or a plurality of first positioning systems other than the second positioning system becomes high. In the terminal positioning method and the terminal positioning system of the present invention, therefore, by monitoring the use state of the first positioning system(s), a failure in the second positioning system is detected.

The present invention also provides a positioning server connected to, via a communication line, a base station that transmits first information for specifying position of a terminal and second information for specifying position of the terminal received from the terminal, the position server specifying the position of the terminal by using at least one of the first and second information, and including: a position specifying unit for specifying position of the terminal with reference to data indicative of association between the first or second information stored in a storage unit and the position of the terminal by using the first or second information; and a failure detector for detecting a failure in a transmitter for transmitting the second information to the terminal by monitoring the specification of the position of the terminal using the first information.

The present invention also provides a program used by a computer for a positioning server connected to, via a communication line, a base station that transmits first information for specifying position of a terminal and second information for specifying position of the terminal received from the terminal, the position server specifying the position of the terminal by using at least one of the first and second information, wherein the program for making the computer execute: a positioning function of specifying position of the terminal with reference to data indicative of association between the first or second information stored in a storage unit and the position of the terminal by using the first or second information; and a failure detecting function of detecting a failure in a transmitter for transmitting the second information to the terminal by monitoring the specification of the position of the terminal using the first information.

In the case where a transmitter for transmitting second information for specifying the position of the terminal fails, the frequency of specifying the position of the terminal using the first information other than the second information becomes high. Consequently, the positioning server and the program of the present invention detect a failure of a transmitter by monitoring specification of the position of the terminal by using the first information for specifying the position of the terminal.

### EFFECT OF THE INVENTION

According to the present invention, in the case of providing a plurality of positioning systems and specifying the position of a terminal, failure detection can be performed without directly detecting a failed positioning system. In particular, also in a large-scale datum-point positioning system having a large number of transmitters for specifying the position of a terminal, which are not connected to a wired network, failure of a transmitter can be detected easily.

### BRIEF DESCRIPTION OF THE DRAWINGS

FIG. 1 is a block diagram showing outline of a terminal positioning system as an embodiment of the present invention;

FIG. 2 is a diagram showing outline of the terminal positioning system as a concrete embodiment of the invention;

FIG. 3 is a diagram showing the configuration of an infrared ray transmitter related with the invention;

FIG. 4 is a diagram showing the configuration of a wireless base station related with the invention;

FIG. 5 is a diagram showing the configuration of a terminal related with the invention;

FIG. 6 is a diagram showing the configuration of a positioning server in first to fourth concrete embodiments of the invention;

FIG. 7 is a diagram showing the configuration of a failure detector in the first concrete embodiment of the invention;

FIG. 8 is a diagram showing information stored in a positioning result storage unit in the first concrete embodiment of the invention;

FIG. 9 is a diagram showing the flow of processes of a positioning result analyzer in the first concrete embodiment of the invention;

FIG. 10 is a diagram showing processes of the positioning result analyzer in the first concrete embodiment of the invention;

FIG. 11 is a diagram showing information stored in a positioning result storage unit in the second concrete embodiment of the invention.

FIG. 12 is a diagram showing the flow of processes of a positioning result analyzer in the second concrete embodiment of the invention;

FIG. 13 is a diagram showing the flow of processes of a positioning result analyzer in a modification of the second concrete embodiment of the invention;

FIG. 14 is a diagram showing the configuration of a failure detector in a third concrete embodiment of the invention;

FIG. 15 is a diagram showing the flow of processes of a positioning result storage unit in the third concrete embodiment of the invention;

FIG. 16 is a diagram showing the flow of processes of a positioning result processor in the third concrete embodiment of the invention;

FIG. 17 is a diagram showing the flow of processes of a positioning result storage unit in a modification of the third concrete embodiment of the invention;

FIG. 18 is a diagram showing the flow of processes of a positioning result analyzer in a modification of the third concrete embodiment of the invention;

FIG. 19 is a diagram showing information stored in a positioning result storage unit in a fourth concrete embodiment of the invention;

FIG. 20 is a diagram showing the flow of processes of a positioning result analyzer in the fourth concrete embodiment of the invention;

FIG. 21 is a diagram showing the flow of processes of a positioning result storage unit in a modification of the fourth concrete embodiment of the invention;

FIG. 22 is a diagram showing the flow of processes of a positioning result analyzer in a modification of the fourth concrete embodiment of the invention;

FIG. 23 is a diagram showing the concept of an overlapped positioning system of a fifth concrete embodiment of the invention;

FIG. 24 is a diagram showing the configuration of a positioning server in the fifth concrete embodiment of the invention;

FIG. 25 is a diagram showing information stored in a transmitter database in the fifth concrete embodiment of the invention;

FIG. 26 is a diagram showing information in a positioning result storage unit in the fifth concrete embodiment of the invention;

FIG. 27 is a diagram showing the flow of processes of a positioning result analyzer in the fifth concrete embodiment of the invention;

FIG. 28 is a diagram illustrating the case where one of infrared ray transmitters in the fifth concrete embodiment of the invention fails;

FIG. 29 is a diagram showing the flow of processes of a positioning result storage unit in a modification of the fifth concrete embodiment of the invention;

FIG. 30 is a diagram showing the flow of processes of a positioning result analyzer in a modification of the fifth concrete embodiment of the invention; and

FIG. 31 is a block diagram showing the case where a computer is used as the positioning server.

### DESCRIPTION OF REFERENCE NUMERALS

1, 1-1 to 1-7, 1-11, and 1-12 infrared ray transmitters
11 transmission controller
12, 22, 32 memories
13 light emitting unit
2, 2-1, 2-2 wireless base stations
21 transmission/reception controller
23, 34 wireless I/Fs
24, 35 antennas
25, 42, 42-1 wired I/Fs
3 terminal
31 controller
33 light receiver
4 positioning server
41, 41-1 position specifying units
43 base station database (DB)
44, 44-1 transmitter databases (DBs)
45, 45-1 failure detectors
451, 453 positioning result analyzers
452 positioning result storage unit
452A base station ID
452B the number of base station positioning times
8-1, 8-2 failed infrared ray transmitters
5 area
6-1, 6-2 wireless areas
7-1, 7-2, 7-5 to 7-8, 7-11, 7-12 infrared ray areas
452C the number of positioning times
452D positioning precision sum
441, 452F position ID-1
442, 452H position ID-2
443, 452E installation position information
452G number of times of position ID-1
452I number of times of position ID-2

### BEST MODE FOR CARRYING OUT THE INVENTION

Embodiments of the present invention will be described in detail hereinbelow with reference to the drawings.

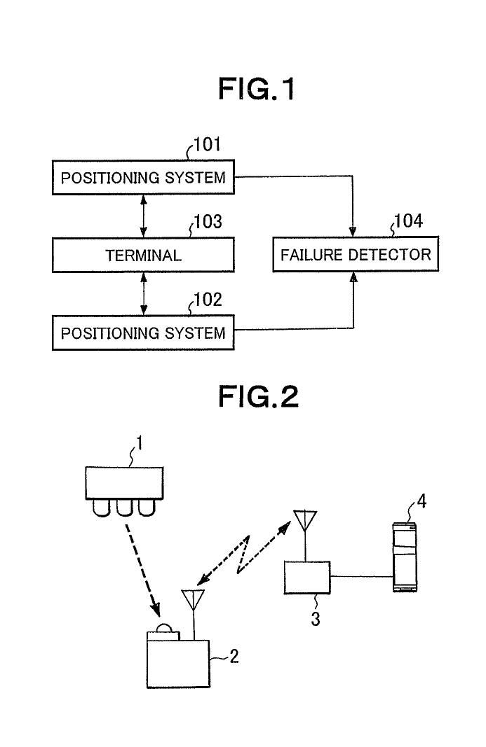

FIG. 1 is a block diagram showing a terminal positioning system as an embodiment of the invention. In FIGS. 1, 101 and 102 denote positioning systems, 103 denotes a terminal, and 104 denotes a failure detector. A positioning process of the terminal 103 may be performed simultaneously in the positioning systems 101 and 102. Alternatively, when the positioning process of one of the positioning systems 101 and 102 is not performed, the positioning process of the other positioning system may be performed. When one of the positioning systems 101 and 102 fails, that is, when the positioning process cannot be performed or the normal positioning process is not performed, the positioning process is performed by the other positioning system. Consequently, the frequency of using the other positioning system increases. The failure detector 104 monitors and detects that the frequency of using the other positioning system increases, thereby detecting a failure in the one of positioning systems. In other words, when a failure occurs in one of the positioning systems 101 and 102, the use state of the other positioning system is monitored. In such a manner, a failure in one of the positioning systems can be detected.

In the positioning systems 101 and 102, higher priority may be placed on execution of a positioning process of one of the positioning systems 101 and 102 or the positioning processes in the positioning systems 101 and 102 may be executed at the same frequency. The positioning precision of the positioning system 101 and that of the positioning system 102 may be the same, or the precision of one of the positioning systems may be higher. The positioning systems 101 and 102 may be positioning systems using different positioning principles to each other or positioning systems using the same positioning principle. In the configuration of concrete embodiments to be described later, for example, the positioning system 101 corresponds to an infrared ray transmitter 1, a wireless base station 2, and a position specifying unit 41 in a positioning server 4. The positioning system 102 corresponds to the wireless base station 2 and the position specifying unit 41 in the positioning server 4. The failure detector 104 corresponds to a failure detector 45 in the positioning server 4. In the concrete embodiments to be described later, in the positioning systems 101 and 102, the wireless base station 2 and the position specifying 41 in the positioning server 4 are common. Alternatively, in the positioning systems 101 and 102, components for structuring systems may be provided separately.

The failure detecting method is not particularly limited. There are the following methods. In a method, the number of positioning times in a predetermined period is monitored. When the number of positioning times of the positioning system 101 exceeds a predetermined number of times, the positioning system 102 determines that a failure occurs. In another method, when the proportion (rate) of the number of positioning times of one of the positioning systems 101 and 102 to the number of positioning times of the positioning systems 101 and 102 exceeds a predetermined value, the other positioning system determines that a failure occurs. In further another method, in the case where the measurement precisions of the positioning systems 101 and 102 are different from each other, an average value of the positioning precisions in a specific area is measured. When the average value exceeds a predetermined value, the positioning system of higher positioning precision determines that a failure occurs.

As the positioning system, a positioning system of specifying the position of a terminal by using the geographic position of a transmitter for transmitting unique information by infrared rays or electric waves, or a positioning system for specifying the position of the terminal by using the geographic position of the wireless base station in the wireless network can be used.

### CONCRETE EMBODIMENTS

Concrete embodiments of the present invention will be further described below.

### First Concrete Embodiment

A first concrete embodiment of the present invention will now be described in detail with reference to the drawings.

FIG. 2 is a diagram showing a general configuration of a terminal positioning system of the first concrete embodiment of the invention.

A positioning system of the concrete embodiment is constructed by the infrared ray transmitter 1, the wireless base station 2, a terminal 3, and the positioning server 4. In place of the infrared ray transmitter, a transmitter that sends an RF-ID and the like may be used.

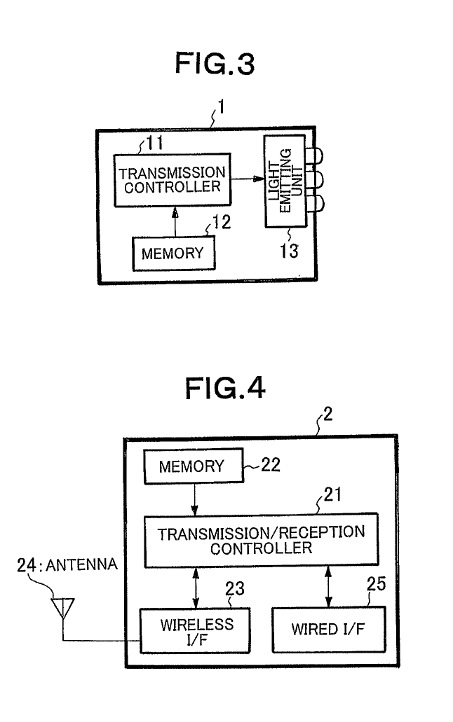

FIG. 3 is a diagram showing the configuration of the infrared ray transmitter 1.

The infrared ray transmitter 1 is constructed by a transmission controller 11, a memory 12, and a light emitting unit 13. In the memory 12, the light emission intervals, the number of light emission times, and the ID number peculiar to the infrared ray transmitter 1 (hereinbelow, called position ID) are stored. The transmission controller 11 reads the light emission intervals, the number of light emission times, and the position ID from the memory 12 and transmits an electric signal to the light emitting unit 13 at a proper timing. When the electric signal is transmitted from the transmission controller 11, the light emitting unit 13 converts the transmitted electric signal to an infrared signal and transmits the infrared signal to the space.

FIG. 4 is a diagram showing the configuration of the wireless base station 2.

The wireless base station 2 is constructed by a transmission/reception controller 21, a memory 22, a wireless interface (I/F) 23, an antenna 24, and a wired interface (I/F) 25.

In the memory 22, the ID number peculiar to the wireless base station 2 (hereinbelow, called base station ID) is stored. The transmission/reception controller 21 periodically transmits the base station ID stored in the memory 22 via the wireless I/F 23 and the antenna 24 to transmit the existence of the wireless network to surrounding terminals. The transmission/reception controller 21 relays information from the terminal 3 received via the wireless I/F 23 and the antenna 24 and transmits it to the positioning server 4 via the wired I/F 25.

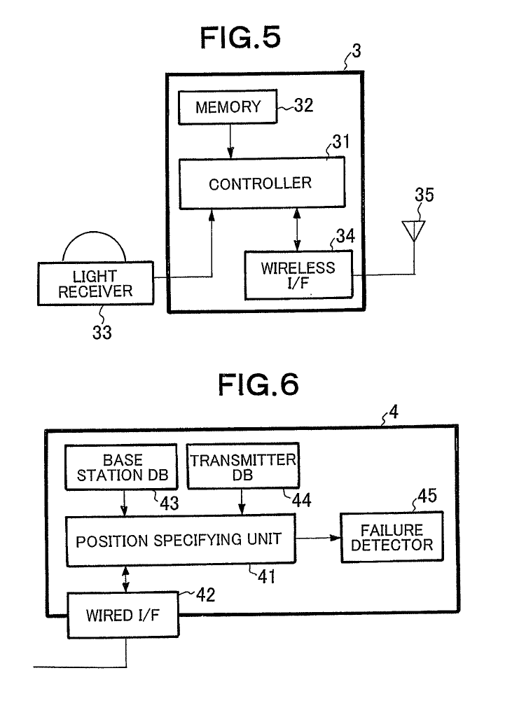

FIG. 5 is a diagram showing the configuration of the terminal 3.

The terminal 3 is constructed by a controller 31, a memory 32, a light receiver 33, a wireless I/F 34, and an antenna 35. The light receiver 33 receives the position ID transmitted from the infrared ray transmitter 1 and notifies the controller 31 of the received position ID. In the memory 32, a reporting method of reporting the position ID notified from the light receiver 33 to the positioning server 4, the ID number peculiar to the terminal 3 (hereinbelow, described as terminal ID), and a base station ID received from the wireless base station 2 via the wireless I/F 34 and the antenna 35 are stored.

The controller 31 transmits the wireless signal via the wireless I/F 34 and the antenna 35 to notify the positioning server 4 of the position ID notified from the light receiver 33 and the terminal ID and the base station ID stored in the memory 32 in accordance with the reporting method stored in the memory 32. There is a case that the position ID is not notified from the light receiver 33. In this case, the terminal ID and the base station ID stored in the memory 32 are reported to the positioning server 4 in accordance with the reporting method stored in the memory 32.

Examples of the reporting method stored in the memory 32 include “reporting in predetermined intervals” and “making a report when the position ID or the base station ID changes from that reported last time”.

FIG. 6 is a diagram showing the configuration of the positioning server 4.

The positioning server 4 is constructed by the position specifying unit 41, a wired I/F 42, a base station database (DB) 43, a transmitter database (DB) 44, and the failure detector 45. The configuration of the positioning server is the minimum for description. In addition, the positioning server 4 may have a function of notifying the user of an alarm. There are various notification methods such as a method of connecting a display and displaying an alarm message on the display, a method of providing an alarm display lamp and lighting up the alarm display lamp when an alarm is generated, and a method of notifying another apparatus of an alarm via the wired I/F 42.

A report from the terminal 3 is relayed by the wireless base station 2 and notified to the position specifying unit 41 via a communication line and the wired I/F 42.

The position specifying unit 41 checks to see whether or not the position ID is included in the report from the terminal 3 and, when the position ID is included, refers to the transmitter database (DB) 44. In the transmitter database 44, a position ID and position information that specifies the place where an infrared ray transmitter having the position ID is installed are stored so as to be associated with each other. The position specifying unit 41 specifies the installation position of the infrared ray transmitter 1 as the position of the terminal 3 with reference to the transmitter database 44 based on the position ID reported from the terminal 3.

The position specifying unit 41 also checks to see whether the position ID is included in the report from the terminal 3 or not. In the case where the position ID is not included, the position specifying unit 41 refers to the base station database 43. In the base station database 43, a base station ID and position information that specifies the place where a wireless base station having the base station ID is installed are stored so as to be associated with each other. The position specifying unit 41 specifies the installation position of the wireless base station 2 as the position of the terminal 3 with reference to the base station database 43 based on the base station ID reported from the terminal 3.

The position of the terminal 3 specified by the position specifying unit 41 can be notified to another apparatus via the wired I/F 42 or notified to the terminal 3 itself or another terminal via the wireless base station 2.

Further, the position specifying unit 41 notifies the failure detector 45 of the base station ID notified from the terminal 3 and information indicating that either the base station database 43 or the transmitter database 44 was referred to for specifying the position of the terminal 3.

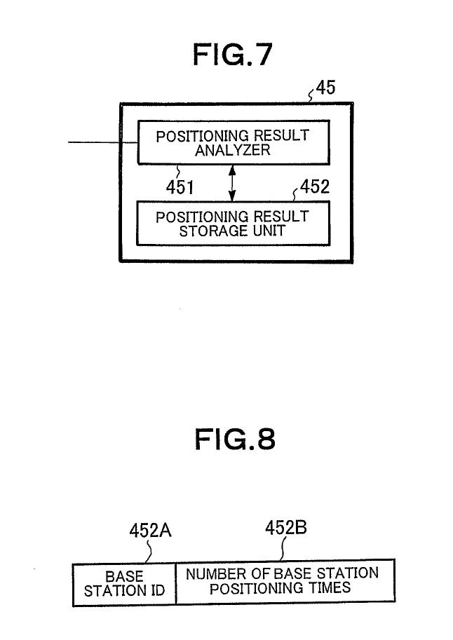

FIG. 7 is a diagram showing the structure of the failure detector 45.

The failure detector 45 is constructed by a positioning result analyzer 451 and a positioning result storage unit 452. In the positioning result storage unit 452, the information of position specification executed by the position specifying unit 41 is stored (held).

FIG. 8 is a diagram showing an entry stored in the positioning result storage unit 452.

In the positioning result storage unit 452, a base station positioning number of times (the number of base station positioning times) 452B as a parameter is stored in association with a base station ID 452A. The base station positioning number of times 452B is a parameter indicative of the number of times that the position specifying unit 41 specifies the position of a terminal by using the position of a wireless base station having the base station ID stored in the base station ID 452A. The entries are deleted in predetermined cycles.

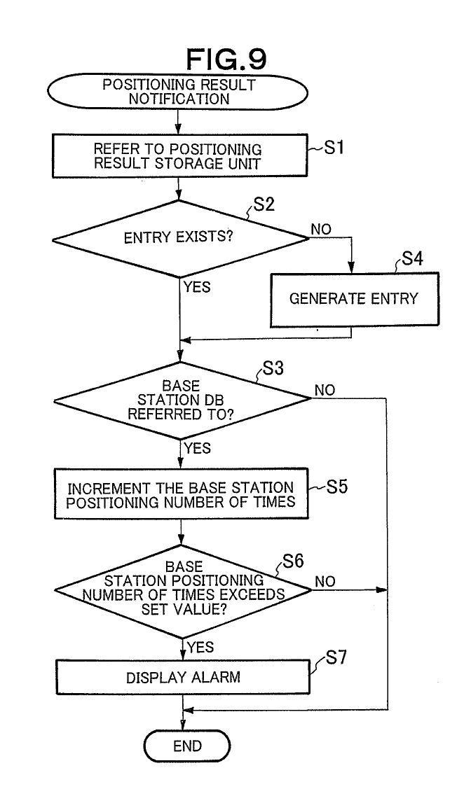

FIG. 9 is a diagram showing the operation of the positioning result analyzer 451.

The positioning result analyzer 451 to which the positioning result is notified from the position specifying unit 41 refers to the positioning result storage unit 452 (step S1) and determines whether there is an entry including the notified base station ID or not (step S2). When an entry is detected, a check is made to see whether the position detecting unit 41 has referred to the base station database 43 or not (step S3). When the position specifying unit 41 has referred to the base station database 43, the number of the base station positioning times included in the detected entry is incremented (increased) (step S5). When there is no entry, an entry including the notified entry is newly generated (step S4), and the program moves to step S3.

After the number of base station positioning times is incremented, whether the value exceeds a set value or not is determined (step S6). In the case where the value does not exceed the set value, the process is finished. In the case where the value exceeds the set value, an alarm is displayed (step S7).

Subsequently, the operation performed in the case where all of infrared ray transmitters operate normally and that performed in the case where some of infrared ray transmitters fail will be described with reference to the drawings.

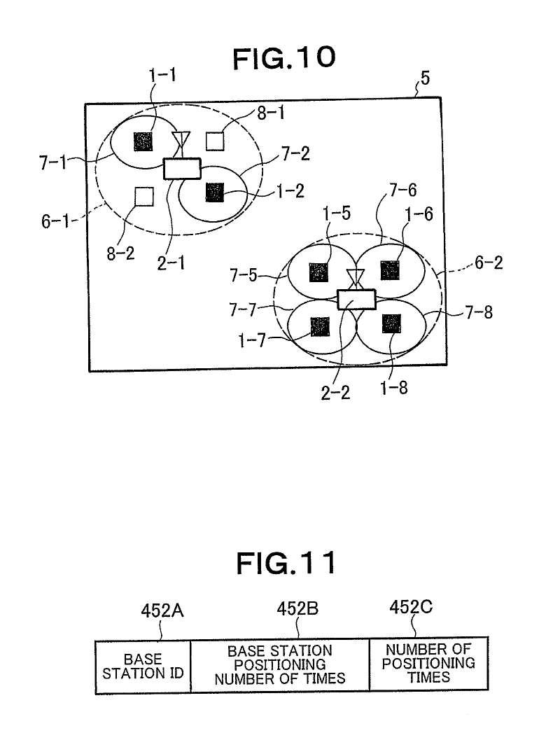

FIG. 10 is a diagram for explaining the operation of an actual system.

In an area 5, two wireless base stations 2-1 and 2-2 are installed and form radio areas 6-1 and 6-2, respectively. In each of the radio areas, four infrared ray transmitters are installed. Concretely, infrared ray transmitters 1-1, 1-2, 8-1, and 8-2 are installed in the radio area 6-1. The infrared ray transmitters 8-1 and 8-2 fail. In the radio area 6-1, only infrared ray areas 7-1 and 7-2 are formed. In the radio area 6-2, infrared ray transmitters 1-5 to 1-8 are installed, and infrared ray areas 7-5 to 7-8 are formed.

The case where the terminal 3 enters the radio area 6-2 will be examined. In this case, four infrared ray areas are formed in the radio area 6-2. In many cases, the position of the terminal 3 existing on the inside is specified by using the position information of the installation positions of the infrared ray transmitters 1-5 to 1-8.

The case where the terminal enters the radio area 6-1 will be examined. In this case, there are only two infrared ray areas in the radio area 6-1. The possibility that the position ID from an infrared ray transmitter cannot be received is higher than that in the radio area 6-2. In this case, as the position of the terminal 3, the position information of the installation position of the wireless base station 2-1 is used. Therefore, the value of the number of the base station positioning times stored in association with the base station ID of the wireless base station 2-1 in the positioning result storage unit 452 in the failure detector 45 of the positioning server 4 becomes large. It is recognized that any of the infrared ray transmitters installed in the radio area 6-1 formed by the wireless base station 2-1 fails, and an alarm can be notified.

The position specification of the terminal 3 using the position ID (unique information) of the infrared ray transmitter 1 can be performed with higher precision than that of the terminal 3 using the base station ID (unique information) of the wireless base station 2. The reason is that the infrared area is narrower than the radio area. In the concrete embodiment, priority on the positioning process using the position ID (unique information) of the infrared ray transmitter 1 is higher than that on the positioning process using the base station ID (unique information) of the wireless base station 2. In the case where the position ID from the infrared ray transmitter 1 cannot be received, the positioning process is performed using the base station ID of the wireless base station 2.

### Second Concrete Embodiment

In the first concrete embodiment, when the terminal 3 does not enter the radio area 6-1 so much in which a failed infrared ray transmitter is installed, the number of positioning times becomes small. There is consequently a problem that it is difficult to find a failure in the infrared ray transmitter.

One of methods of solving the problem is a method of using, as a parameter of failure detection, the ratio between all of the number of positioning times performed in a specific radio area and the number of times of positioning of wireless base stations is used.

The details of the second concrete embodiment will be described with reference to the drawings.

FIG. 11 is a diagram showing information stored in the positioning result storage unit 452 in the concrete embodiment.

The base station ID 452A and the number of the base station positioning times 452B are similar to those in the first concrete embodiment, so that their description will not be repeated.

The positioning number of times 452C is the total number of times of positioning executed in a radio area formed by the wireless base station having the base station ID stored in the base station ID 452A.

Different from the first concrete embodiment, the information stored in the positioning result storage unit 452 is not deleted after a predetermined period.

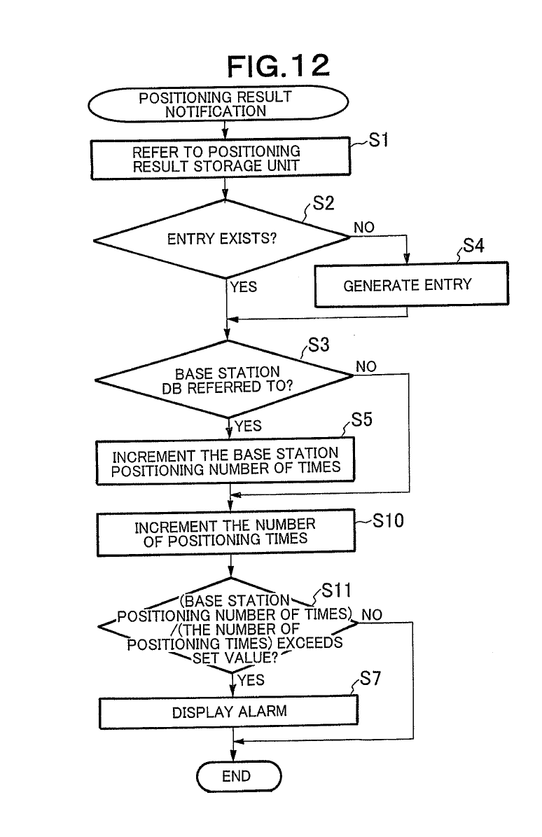

FIG. 12 is a diagram showing the operation of the positioning result analyzer 451 in the second concrete embodiment.

Since steps S1 to S7 are the same as those of the first concrete embodiment, the detailed description will not be repeated.

After completion of the step S5, “the number of positioning times” as the parameter associated with the notified base station ID is incremented (step S11). After that, the ratio between the number of base station positioning times and the number of positioning times is calculated and whether the calculated ratio exceeds a set value or not is determined (step S11). When the ratio exceeds the set value, the program moves to the step S7. When the ratio does not exceed the set value, the process is finished.

In the above-described configuration, when the number of positioning times is small, there is the possibility that a failure is detected erroneously. In such a case, it is sufficient to take a method in which a failure is not detected when the number of positioning times is not equal to or larger than preset number of times.

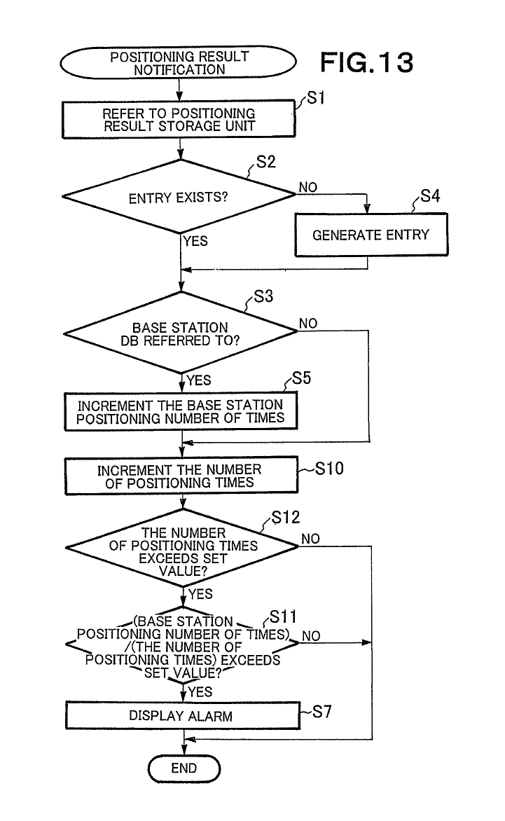

FIG. 13 is a diagram showing operation of the positioning result analyzer 451 in a modification of the second concrete embodiment.

The steps S1 to S7 are similar to those of the first concrete embodiment and the steps S10 and S11 are similar to those of the second concrete embodiment, so that the detailed description will not be repeated.

After completion of the step S10, a check is made to see whether the parameter “the number of positioning times” exceeds the set value or not (step S12). In the case where the parameter exceeds the set value, the program moves to the step S11. When the parameter does not exceed the set value, the process is finished.

### Third Concrete Embodiment

In the second concrete embodiment, each time positioning of a terminal is performed, the positioning result analyzer 451 detects a failure. Alternatively, failure detection can be performed in predetermined intervals on data stored in the positioning result storage unit 452.

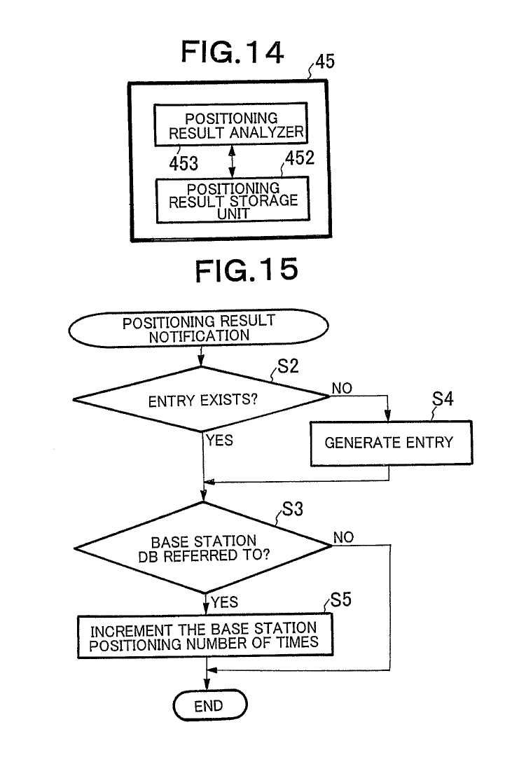

FIG. 14 is a diagram showing the configuration of the failure detector 45 in the third concrete embodiment.

The position specifying unit 41 notifies the positioning result storage unit 452 as a component of the failure detector 45 of the base station ID reported from the terminal 3 and information indicating that either the base station database 43 or the transmitter database 44 was referred for specifying the position of the terminal.

FIG. 15 is a diagram showing the flow of processes in the positioning result storage unit 452 which has received the notification. The steps S2 to S5 are the same processes as those of FIG. 9 and their description will not be repeated. The information stored is information of the format shown in FIG. 8.

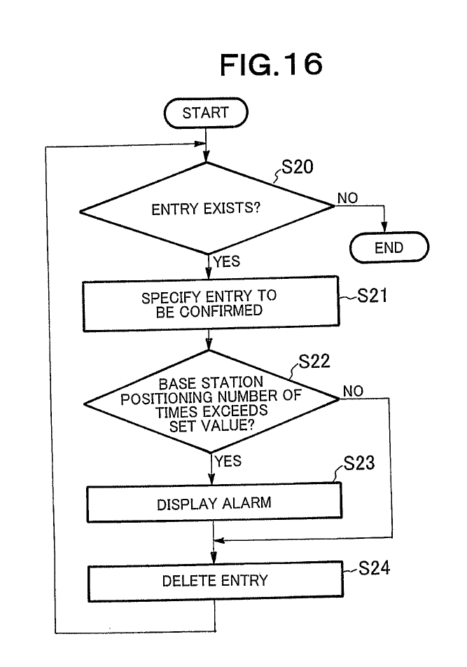

FIG. 16 is a diagram showing the flow of processes in the positioning result analyzer 453 in the third concrete embodiment.

The positioning result analyzer 453 executes the process at preset intervals.

The positioning result analyzer 453 determines whether there is an entry or not with reference to the positioning result storage unit 452 (step S20). When there is no entry, the process is finished. When there is an entry, an entry to be checked is specified (step S21) and whether the parameter “number of base station positioning times” exceeds the set value or not is determined (step S22). When the parameter exceeds the set value, an alarm is displayed (step S23) and the entry is deleted (step S24). When the parameter does not exceed the set value, the entry is deleted (step S24).

After completion of the process in step S24, the program returns to step S20.

In the third concrete embodiment as well, in a manner similar to the second concrete embodiment, the ratio between the number of base station positioning times and the total number of positioning times, instead of the number of base station positioning times can be used as a determination parameter.

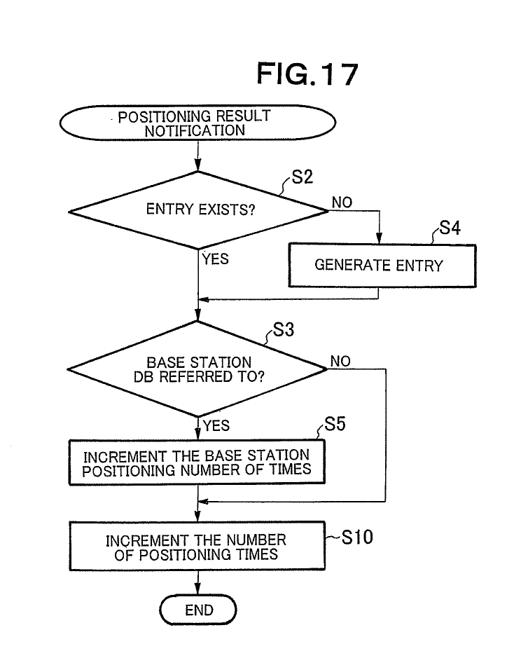

FIG. 17 is a diagram showing the flow of processes of the positioning result storage unit 452 in a modification of the third concrete embodiment. The processes in the steps S2 to S5 and the step S100 are the same as those of the second concrete embodiment and their description will not be repeated.

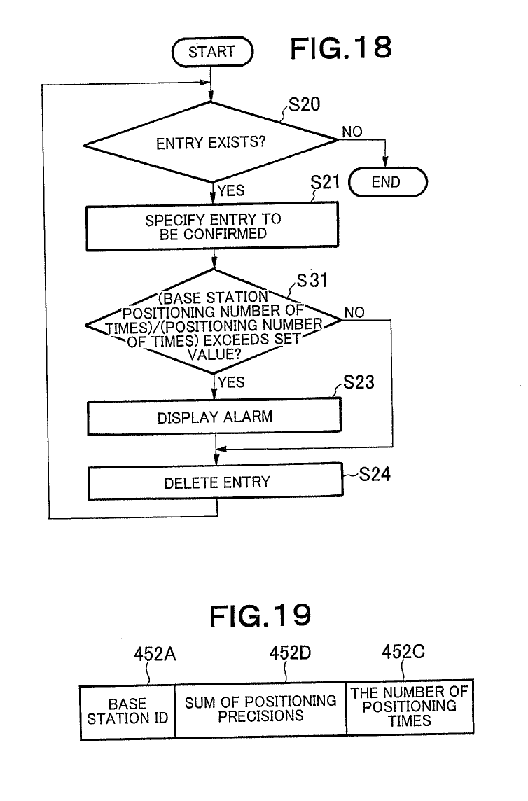

FIG. 18 is a diagram showing the flow of processes of the positioning result analyzer 453 in the modification of the third concrete embodiment. The processes in the steps S20 to S24 are the same as those of the third concrete embodiment, and their detailed description will not be repeated.

After completion of the step S21, the ratio between the parameter “number of base station positioning times” and the parameter “number of positioning times” is calculated and whether the calculation result exceeds the set value or not is determined (step S31). When the calculation result exceeds the set value, the program moves to step S23. When the calculation result does not exceed the set value, the program moves to step S24.

### Fourth Concrete Embodiment

In the first to third concrete embodiments, a failure of an infrared ray transmitter is detected by using the number of times of specifying the position of a terminal by using the position of a wireless base station.

As another method, a failure of an infrared ray transmitter is detected using an average value of positioning precision.

The positioning precision in the case where the position of a terminal is specified using the position of an infrared ray transmitter is set to 3 m (meters), the positioning precision in the case where the position of a terminal is specified using the position of a wireless base station is set to 30 m (meters), and the position specifying unit 41 notifies the failure detector 45 of the base station ID notified from the terminal 3 and the positioning precision.

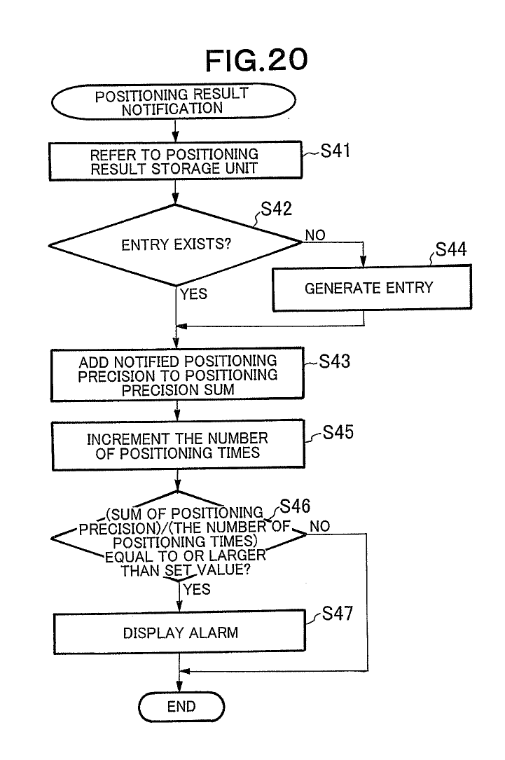

FIG. 19 is a diagram showing information stored in the position result storage unit 452 in the fourth concrete embodiment. As shown in FIG. 19, the base station ID 452A, positioning precision sum 452D, and the number 452C of positioning times are stored in the positioning result storage unit 452. FIG. 20 is a diagram showing the flow of processes in the positioning result analyzer 451 in the concrete embodiment. The positioning precision sum is total of adding the notified positioning precisions (3 m and 30 m).

The position result analyzer 451 to which the positioning result is notified from the position specifying unit 41 refers to the positioning result storage unit 452 (step S41) and a check is made to see whether there is an entry which matches the notified base station ID or not (step S42). When an entry exists, the notified positioning precisions are added to the parameter “positioning precision sum” (step S43). When no entry exists, an entry is generated using the notified base station ID (step S44) and the program moves to step S43.

After that, the parameter “number of positioning times” is incremented (step S45). The parameter “positioning precision sum” is divided by the parameter “positioning number of times”, and a division result is compared with the set value (step S46). When the division result is equal to or larger than the set value, an alarm is displayed (step S47), and the process is finished. When the division result is less than the set value, the process is finished as it is.

In the fourth concrete embodiment, the process is executed each time a notification from the position specifying unit 41 is received. In a manner similar to the third concrete embodiment, a method of performing the process at predetermined intervals can be also employed.

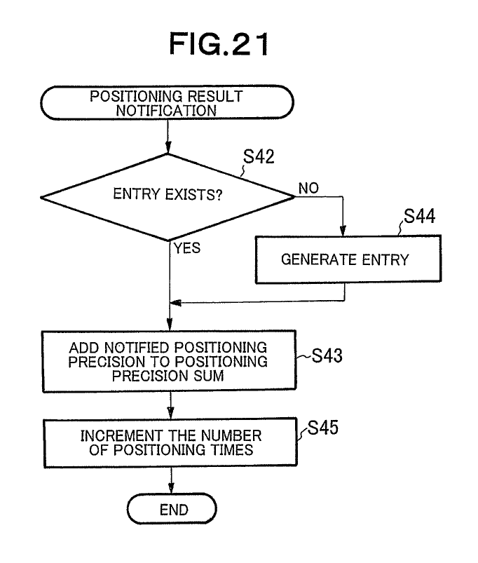

FIG. 21 is a diagram showing the flow of process in the positioning result storage unit 452 in the modification. Since the processes in steps S42 to S45 are the same as those in FIG. 20, their description will not be repeated.

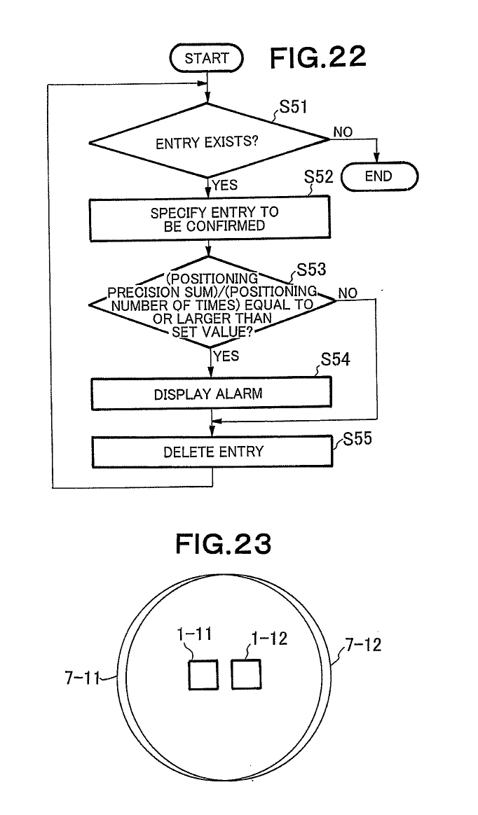

FIG. 22 is a diagram showing the flow of processes in the positioning result analyzer 451 in the modification.

First, the positioning result analyzer 451 checks to see whether there is an entry or not with reference to the positioning result storage unit 452 (step S51). In the case where there is no entry, the process is finished. When there is an entry, an entry to be checked is specified (step S52), the parameter “positioning precision sum” is divided by the parameter “the number of positioning times”, and a division result is compared with the set value (step S53).

When the division result is equal to or larger than the set value, an alarm is displayed (step S54) and, after that, the entry is deleted (step S55). When the division result is less than the set value, the program moves to step S55.

### Fifth Concrete Embodiment

In the first to fourth concrete embodiments, the methods of detecting a failure of an infrared ray transmitter in a positioning system obtained by combining a positioning system having high positioning precision using the installation position of an infrared ray transmitter and a positioning system having low positioning precision using the installation position of a wireless base station have been described.

As a positioning system other than the above, the same positioning systems are overlapped as a measure against a failure.

FIG. 23 is a diagram showing a state of an infrared ray area in the case where positioning systems using the installation position of an infrared ray transmitter are overlapped.

Infrared ray transmitters 1-11 and 1-12 are installed in almost the same position and generate infrared ray areas 7-11 and 7-12, respectively. The position IDs transmitted from the infrared ray transmitters 1-11 and 1-12 are different from each other. It is assumed that the infrared ray transmitter 1-11 transmits “1” and the infrared ray transmitter 1-12 transmits “2”. The position ID transmission frequencies of the infrared ray transmitters 1-11 and 1-12 are the same but transmission timings are not synchronous.

When the terminal 3 enters a generated infrared ray area, the position ID “1” or “2” is received. Since the infrared ray areas 7-11 and 7-12 are almost the same and the transmission frequency is the same, the reception probabilities of the position ID “1” and the position ID “2” are almost the same.

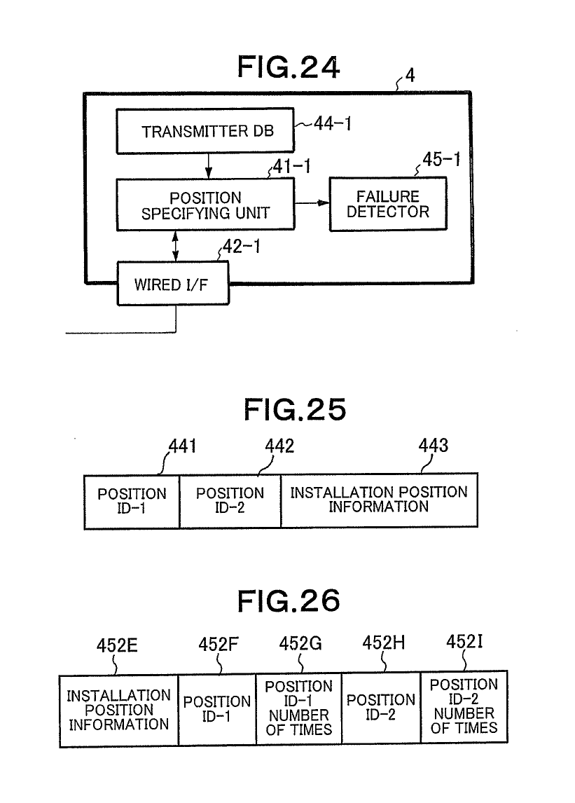

FIG. 24 is a diagram showing the configuration of the positioning server 4 in the concrete embodiment.

The positioning server 4 in the concrete embodiment is constructed by a position specifying unit 41-1, a wired I/F 42-1, a transmitter database (DB) 44-1, and a failure detector 45-1.

The position specifying unit 41-1 receives the position ID from the terminal 3 via the wireless base station 2 and the wired I/F 42-1, obtains position information of the installation position of the transmitter having the notified position ID with reference to the transmitter database 44-1, and specifies the position of the terminal 3.

FIG. 25 is a diagram showing information stored in the transmitter database 44-1 in the concrete embodiment.

In the concrete embodiment, two infrared ray transmitters are installed in the same place, and the positions ID-1 441 and ID-2 442 of the two infrared ray transmitters are stored in association with the installation position information 443.

After completion of specification of the position of the terminal 3, the position specifying unit 41-1 notifies the failure detector 45-1 of the positioning result. In the fifth concrete embodiment, the position information (corresponding to the installation position information 443) of the terminal 3 specified as the positioning result and the position ID notified from the terminal 3 are notified.

The configuration of the failure detector 45-1 is similar to that of the failure detector 45, so that the description will not be repeated. In the fifth concrete embodiment, the format of information stored in the positioning result storage unit 452 varies.

FIG. 26 is a diagram showing information stored in the positioning result storage unit 452 in the concrete embodiment.

In the positioning result storage unit 452, installation position information 452E, position ID-1 452F, the number 452G of times of position ID-1, position ID-2 452H, and the number 452I of times of position ID-2 are stored so as to be associated with each other. The installation position information 452E is position information specified as the position of the terminal 3 by the position specifying unit 41-1 and notified from the position specifying unit 41-1. Each of the number 452G of times of the position ID-1 and the number 452I of times of the position ID-2 is a parameter indicative of the number of times that the position ID associated with the installation position information 452E is used.

Concretely, the position information of the installation position with which the infrared ray transmitters 1-11 and 1-12 in FIG. 23 are associated is “column number F-2”. When the case where the position ID “1” is received by the terminal 3 and the position is specified occurs four times and the case where the position ID “2” is received by the terminal 3 and the position is specified occurs six times, “column number F-2” is set for the installation position information 452E, “1” is set as the position ID-1 452F, “4” is set as the number 452G of times of position ID-1, “2” is set as the position ID-2 452H, and “6” is set as the number 452I of times of the position ID-2.

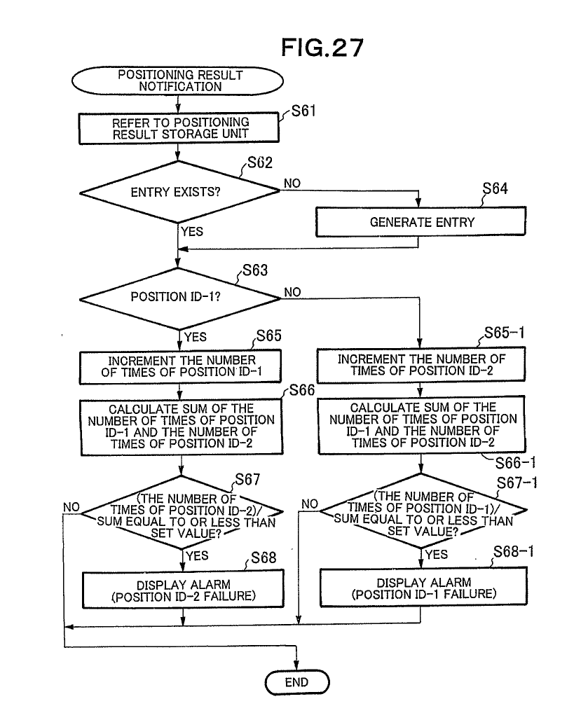

FIG. 27 is a diagram showing the flow of processes of the positioning result analyzer 451 of the failure detector 45-1.

The positioning result analyzer 451 to which the positioning result is notified from the position specifying unit 41-1 refers to the positioning result storage unit 452 (step S61). At this time, a check is made to see whether or not there is an entry associated with the position information of the notified installation position (step S62). When there is an entry, a check is made to see if the notified position ID is the position ID-1 452F or the position ID-2 452H (step S63). When there is no entry, an entry is newly generated (step S64).

The case where the notified position ID coincides with the value stored in the position ID-1 452F will be described below. Since processes (steps S65-1 to S68-1) performed in the case where the notified position ID coincides with the value stored in the position ID-2 452H are similar to the above, their description will not be repeated.

After confirming that the notified position ID coincides with the value stored in the position ID-1 452F, the value of the number 452G of times of the position ID-1 is incremented (step S65). After that, the sum of the values of the number 452G of times of position ID-1 and the number 452I of times of position ID-2 is calculated (step S66). Subsequently, the ratio between the sum and the number 452I of times of the position ID-2 ((the value of the number 452I of times of position ID-2)/sum) is calculated, and whether or not the calculated value is equal to or less than the set value is determined (step S67). In the case where the calculated value is equal to or less than the set value, an alarm of “failure in an infrared ray transmitter having the position ID stored in the position ID-2 452H” is displayed (step S68), and the process is finished. In the case where the calculated value is larger than the set value, the process is finished.

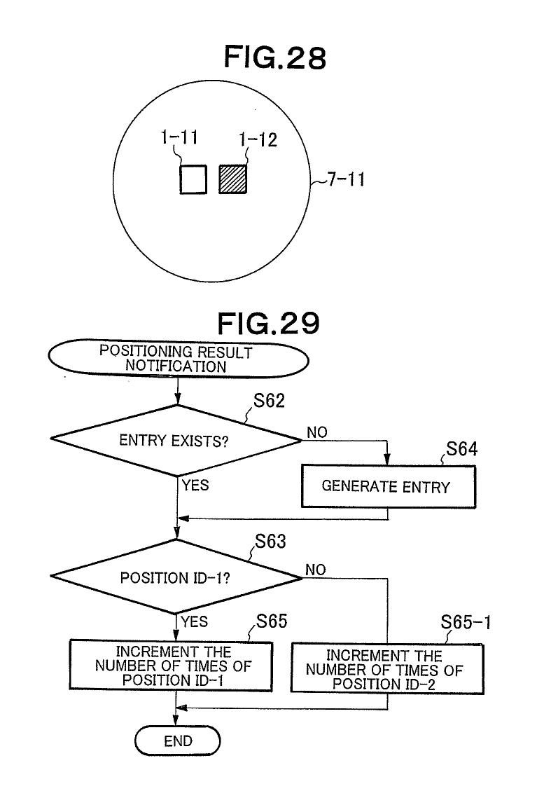

FIG. 28 is a diagram showing the state of an infrared ray area in the case where the infrared ray transmitter 1-12 fails.

Although the infrared ray transmitter 1-12 fails, the infrared ray transmitter 1-11 operates normally. Consequently, when the terminal 3 enters the area, the position of the terminal 3 can be specified. Since the terminal 3 receives only the position ID “1” transmitted from the infrared ray transmitter 1-11, only the value of the number 452G of times of position ID-1 associated with the position ID “1” increases in the information stored in the positioning result storage unit 452. Therefore, when the value of the ratio calculated in step S67 decreases to the set value or less, a failure of the infrared ray transmitter 1-12 is detected.

The concrete embodiment has been described on assumption that two transmitters are installed in the same place. The number of transmitters installed in the same place may be three or more. In this case, data is added so that the number of sets of two parameters of the position ID and the number of position IDs in the information stored in the positioning result storage unit 452 coincides with the number of transmitters installed.

In the concrete embodiment, although the process for detecting a failure is performed each time a notification from the position specifying unit 41-1 is received, a method of performing the process every predetermined time may be employed.

FIG. 29 is a diagram showing the flow of processes in a positioning result storage unit F2 in the modification. Since the processes in steps S62 to S65 (S65-1) are the same as those in the fifth concrete embodiment, their description will not be repeated.

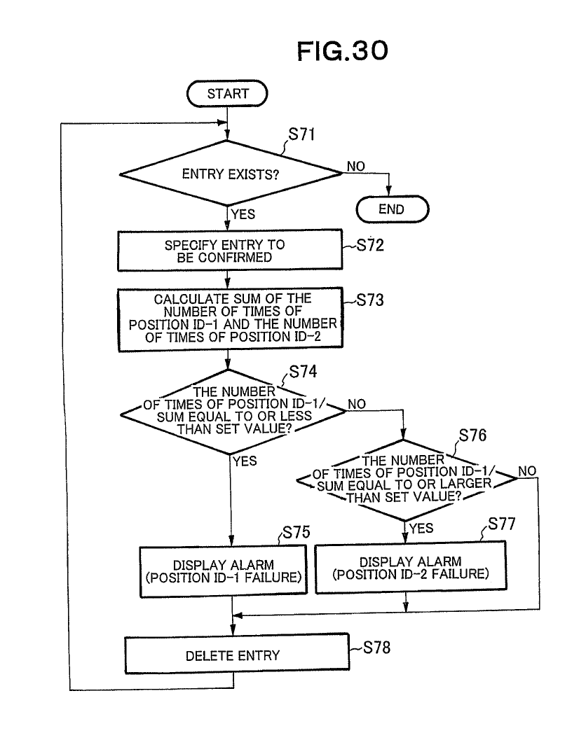

FIG. 30 is a diagram showing the flow of processes of the positioning result analyzer 451 in the modification. The processes are executed at predetermined intervals.

The positioning result analyzer 451 checks to see whether an entry exists in the positioning result storage unit 452 or not (step S71). When an entry exists, an entry to be checked is specified (step S72). When no entry exists, the process is finished.

When an entry is specified, the sum 452I of the number 452G of times of position ID-1 and the number 452I of times of position ID-2 included in the specified entry is calculated (step S73). After that, the ratio between the number of times of position ID-1 and the sum is calculated and compared with the set value T1 (step S74). In the case where the ratio is equal to or less than the set value T1, an alarm of “failure in a transmitter having the position ID stored in the position ID-1 452F” is displayed (step S75), and the entry is deleted (step S78).

In the case where the ratio between the number of times of position ID-1 and the sum is larger than the set value T1, whether the ratio is equal to or larger than the set value T2 or not is determined (step S76). In the case where the ratio is equal to or larger than the set value T2, an alarm “failure of a transmitter having the position ID stored in the position ID-2 452H” is displayed (step S77), and the entry is deleted (step S78). When the ratio is less than the set value T2, the program moves to step S78.

After completion of erasure of the entry, the program moves to step S71.

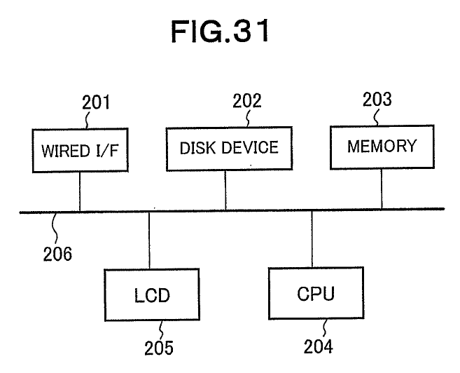

A computer as shown in FIG. 31 may be employed as the positioning server described in each of the concrete embodiments.

The information (position ID, base station ID, and the like) from the wireless base station 2 is stored in a disk device 202 such as a hard disk or a storage portion such as a DRAM via a wired interface (I/F) 201. In the storage portion, information in the base station database 43 and the transmitter database 44 is stored. A CPU 204 realizes the functions of the position specifying unit and the failure detector described above and performs processes based on a program describing the functions (in this case, the program is stored in the disk device 202) (the functions of the failure detector have been already described with reference to FIGS. 9, 12, 13, 15 to 18, 20 to 22, 27, 29, and 30). In other words, the present invention is realized as a program product stored in a disk device serving as the storage portion of the computer and having codes that make the computer execute the functions of the position specifying unit and the failure detector. An LCD (Liquid Crystal Display) 205 is display means for displaying an alarm and the like. 206 denotes a bus such as a data bus. 203 denotes a memory for storing data necessary for the computing process of the program.

The program can be recorded on a computer-readable information recording medium such as an FD (floppy disk), a CD-ROM, a DVD, a semiconductor memory such as a flash memory, or the like. By reading the program recorded on an FD, CD-ROM, or the like, storing the program into the storage portion such as the disk device 202, and executing the process, the computer can be made function as a positioning server. The present invention also relates to the program itself. In the case of downloading the program to a computer functioning as a positioning server via a communication line, an action of transmitting/receiving the program is also included in the right of the present invention. The functions of the position specifying unit 41 and the failure detector 45 can be realized by software. They can be also realized by hardware using a dedicated IC.

Representative concrete embodiments and examples of the present invention have been described above. The present invention may be embodied in various other forms without departing from its spirit or main features. The foregoing concrete embodiments are simply illustrative and should not be interpreted in a limited manner. The scope of the invention is defined by the scope of claims and is not limited to the description of the specification and the abstract. Further, all modifications and changes that fall within meets and bounds of the claims or equivalence of such meets and bounds lie within the scope of the present invention.

### INDUSTRIAL APPLICABILITY

The present invention is used for a terminal positioning system for specifying the position of a terminal by providing a plurality of positioning systems and, particularly, is applied to an apparatus for determining the position of a terminal with a positioning system using a datum point of transmitting, in particular, an RF-ID, infrared ray, and the like.

1. A terminal positioning method of specifying position of a terminal by using at least one of a plurality of positioning systems,
wherein a use state of one or more first positioning systems in the plurality of positioning systems is monitored by a failure detector, thereby detecting a failure of at least one second positioning system other than the one or plurality of first positioning systems.

2. The terminal positioning method according to claim 1, wherein priority of a positioning process is determined for each of the plurality of positioning systems, and the priority of the positioning process on the second positioning system is higher than that of the first positioning system.

3. The terminal positioning method according to claim 1, wherein the second positioning system is a positioning system capable of performing positioning at precision higher than that of the first positioning system.

4. The terminal positioning method according to claim 1, wherein the failure detection is performed by monitoring the number of positioning times in a predetermined period in a specific area, of the first positioning system and, when the number of positioning times exceeds a predetermined number of times, determining that the second positioning system cannot be used due to a failure in the area.

5. The terminal positioning method according to claim 1, wherein the failure detection is performed by monitoring the number of positioning times in a specific area, monitoring the number of positioning times of the first positioning system in the area and, when the ratio of the number of positioning times of the first positioning system to the number of positioning times in the specific area exceeds a predetermined value, determining that the second positioning system cannot be used due to a failure in the area.

6. The terminal positioning method according to claim 1, wherein the failure detection is performed by calculating an average value of positioning precisions in a specific area and,
in the case where the average value exceeds a predetermined value, determining that the second positioning system cannot be used due to a failure.

7. The terminal positioning method according to claim 4, wherein when it is determined by the failure detector that the second positioning system cannot be used due to a failure in the area, the failure detector specifies the area as a range in which a failure occurs.

8. The terminal positioning method according to claim 5, wherein when it is determined by the failure detector that the second positioning system cannot be used due to a failure in the area, the failure detector specifies the area as a range in which a failure occurs.

9. The terminal positioning method according to claim 6, wherein when it is determined by the failure detector that the second positioning system cannot be used due to a failure in the area, the failure detector specifies the area as a range in which a failure occurs.

10. The terminal positioning method according to claim 1, wherein the first and second positioning systems are positioning systems using different positioning principles to each other.

11. The terminal positioning method according to claim 1, wherein the second positioning system is a positioning system for specifying position of the terminal by using a geographic position of a transmitter for transmitting unique information by infrared ray or electric wave.

12. The terminal positioning method according to claim 1, wherein the first positioning system is a positioning system for specifying position of the terminal by using a geographic position of a wireless base station in a wireless network.

13. The terminal positioning method according to claim 1, wherein the failure detection is executed each time the position of the terminal is detected.

14. The terminal positioning method according to claim 1, wherein the failure detector has a positioning result storage unit for holding a result of specification of the position of the terminal, and
the failure detector executes detection of a failure at predetermined intervals with reference to the positioning result storage unit.

15. The terminal positioning method according to claim 1, wherein the first and second positioning systems are positioning systems using the same positioning principle.

16. A terminal positioning system including a plurality of positioning systems and specifying position of a terminal by using at least one of the plurality of positioning systems,
wherein a use state of one or a plurality of first positioning systems in the plurality of positioning systems is monitored by a failure detector, thereby detecting a failure in at least one second positioning system other than the one or plurality of first positioning systems.

17. The terminal positioning system according to claim 16, wherein priority of a positioning process is determined for each of the plurality of positioning systems, and the priority of the positioning process on the second positioning system is higher than that of the first positioning system.

18. The terminal positioning system according to claim 16, wherein the second positioning system is a positioning system capable of performing positioning at precision higher than that of the first positioning system.

19. The terminal positioning system according to claim 16, wherein the first and second positioning systems are positioning systems using different positioning principles to each other.

20. The terminal positioning system according to claim 16, wherein the second positioning system is a positioning system for specifying position of the terminal by using a geographic position of a transmitter for transmitting unique information by infrared ray or electric wave.

21. The terminal positioning system according to claim 16, wherein the first positioning system is a positioning system for specifying position of the terminal by using a geographic position of a wireless base station in a wireless network.

22. The terminal positioning system according to claim 16, wherein the failure detector has a positioning result storage unit for holding a result of position specification of the terminal, and a positioning result analyzer for analyzing the result of the position specification and detecting a failure in at least one second positioning system, and
the positioning result analyzer executes detection of a failure at predetermined intervals with reference to the positioning result storage unit.

23. The terminal positioning system according to claim 16, wherein the first and second positioning systems are positioning systems using the same positioning principle.

24. A positioning server connected to, via a communication line, a base station that transmits first information for specifying position of a terminal and second information for specifying position of the terminal received from the terminal, the position server specifying the position of the terminal by using at least one of the first and second information, and comprising:
a position specifying unit for specifying position of the terminal with reference to data indicative of association between the first or second information stored in a storage unit and the position of the terminal by using the first or second information; and
a failure detector for detecting a failure in a transmitter for transmitting the second information to the terminal by monitoring the specification of the position of the terminal using the first information.

25. A program used by a computer for a positioning server connected to, via a communication line, a base station that transmits first information for specifying position of a terminal and second information for specifying position of the terminal received from the terminal, the position server specifying the position of the terminal by using at least one of the first and second information, wherein the program for making the computer execute:
a position specifying function of specifying position of the terminal with reference to data indicative of association between the first or second information stored in a storage unit and the position of the terminal by using the first or second information; and
a failure detecting function of detecting a failure in a transmitter for transmitting the second information to the terminal by monitoring the specification of the position of the terminal using the first information.
